(19) United States
(12) Patent Application Publication
(10) Pub. No.: US 2023/0131671 A1
(43) Pub. Date: Apr. 27, 2023

(54) Electronic Signage Assembly

(71) Applicant: Luc Alecoeur, Ottawa (CA)

(72) Inventor: Luc Alecoeur, Ottawa (CA)

(21) Appl. No.: 17/508,434

(22) Filed: Oct. 22, 2021

(51) Int. Cl. B60Q 1/50; G09F 9/30; G09F 21/04; G08C 17/00

(52) U.S. Cl. CPC B60Q 1/503; G09F 9/30; G09F 21/0485; G08C 17/00

(57) ABSTRACT

An electronic signage assembly for communicating with a person proximate to a vehicle includes a message module, which comprises a receiver communicatively engaged to a screen, and a remote controller, which comprises a transmitter communicatively engaged to a selector. The screen is rectangular and can selectively display a respective preprogrammed message of a plurality of preprogrammed messages. A plurality of resiliently compressible cups is engaged to the message module and can be compressed between the message module and a window of a vehicle to mount the message module with the screen being visible through the window. The transmitter is in wireless communication with the receiver. The selector, which is communicatively engaged to the transmitter, is utilized by a user for selection by of a respective preprogrammed message. The transmitter communicates the selection to the message module for display of the respective preprogrammed message to persons proximate to the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to signage assemblies and more particularly pertains to a new signage assembly for communicating with a person proximate to a vehicle. The present invention discloses a signage assembly comprising a rectangular screen, which is mountable to a window of a vehicle by suction cups. The signage assembly includes a remote controller, which allows a user to select a message so that the message is displayed for viewing by a person proximate to the vehicle.

### (2) Description of Related Art Including Information Disclosed Under 37 CFR 1.97 and 1.98

The prior art relates to signage assemblies. While the prior art includes a variety of signage assembly that are mountable to windows of vehicles for displaying messages, the prior art lacks a signage assembly comprising a rectangular screen, which is mountable to a window of a vehicle by suction cups. The signage assembly includes a remote controller, which allows a user to select a message so that the message is displayed for viewing by a person proximate to the vehicle.

### BRIEF SUMMARY OF THE INVENTION

An embodiment of the disclosure meets the needs presented above by generally comprising a message module, which comprises a receiver and a screen, and a remote controller, which comprises a transmitter and a selector. The screen is rectangular and communicatively engaged to the receiver. The screen is configured to selectively display a respective preprogrammed message of a plurality of preprogrammed messages. A plurality of cups, which are resiliently compressible, is engaged to the message module and configured to be compressed between the message module and a window of a vehicle to suctionally mount the message module to the window, with the screen being visible through the window. The transmitter is in wireless communication with the receiver. The selector is communicatively engaged to the transmitter and configured for input of a selection by a user of a respective preprogrammed message. The transmitter communicates the selection to the message module for display of the respective preprogrammed message to persons proximate to the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an electronic signage assembly according to an embodiment of the disclosure.

FIG. 2 is an exploded view of an embodiment of the disclosure.

FIG. 3 is a front view of an embodiment of the disclosure.

FIG. 4 is a rear view of an embodiment of the disclosure.

FIG. 5 is a bottom view of an embodiment of the disclosure.

FIG. 6 is a side view of an embodiment of the disclosure.

FIG. 7 is an in-use view of an embodiment of the disclosure.

### DETAILED DESCRIPTION OF THE INVENTION

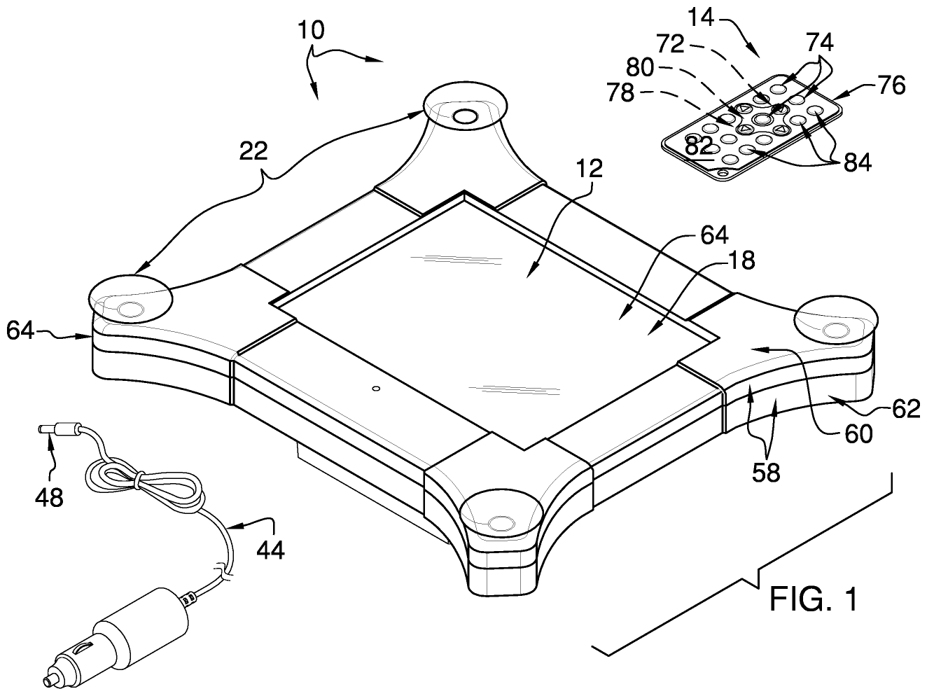

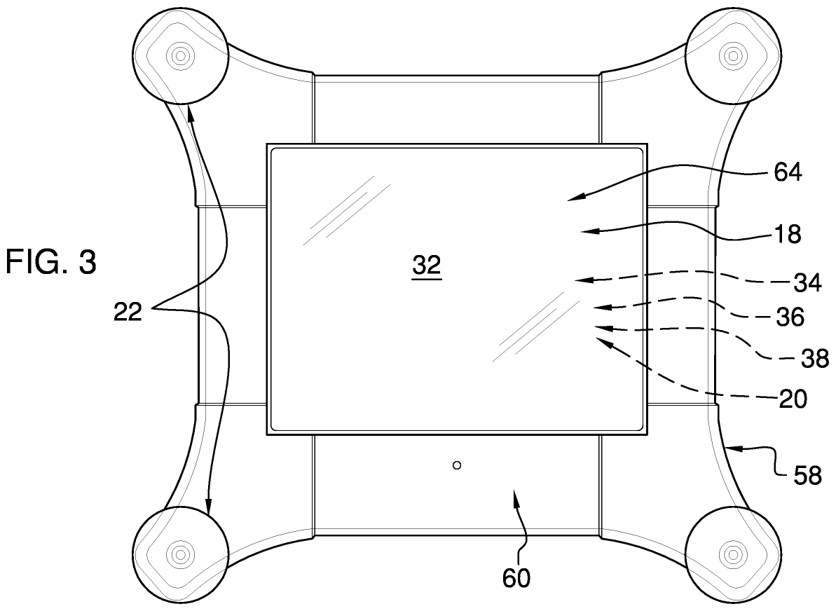

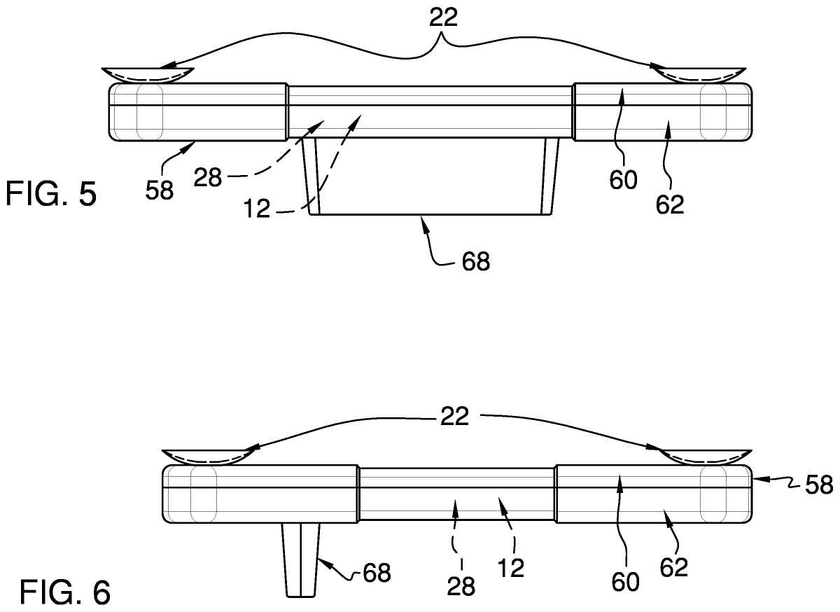

With reference now to the drawings, and in particular to FIGS. 1 through 7 thereof, a new signage assembly embodying the principles and concepts of an embodiment of the disclosure and generally designated by the reference numeral 10 will be described.

As best illustrated in FIGS. 1 through 7, the electronic signage assembly 10 generally comprises a message module 12 and a remote controller 14. The message module 12 comprises a receiver 16 and a screen 18. The screen 18 is rectangular and is communicatively engaged to the receiver 16. The screen 18 is configured to selectively display a respective preprogrammed message 20 of a plurality of preprogrammed messages 20.

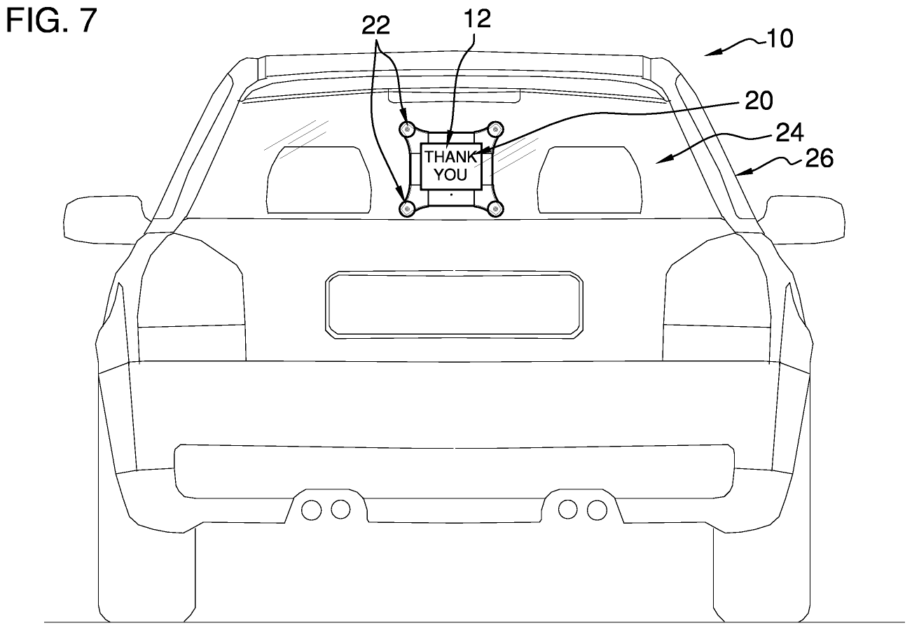

A plurality of cups 22 is engaged to the message module 12. The cups 22 comprise rubber, silicone, or elastomer and thus are resiliently compressible. The cups 22 are configured to be compressed between the message module 12 and a window 24 of the vehicle 26 to suctionally mount the message module 12 to the window 24, with the screen 18 being visible through the window 24, as shown in FIG. 7.

The message module 12 also comprises a display housing 28, which defines an interior space 30. The receiver 16 is engaged to the display housing 28 and is positioned in the interior space 30. The screen 18 is engaged to a first face 32 of the display housing 28. A display battery 34, a microprocessor 36, and a data storage module 38 are engaged to the display housing 28 and are positioned in the interior space 30. The microprocessor 36 is operationally engaged to the receiver 16, the display battery 34, the screen 18, and the data storage module 38. The plurality of preprogrammed messages 20 is positioned on the data storage module 38.

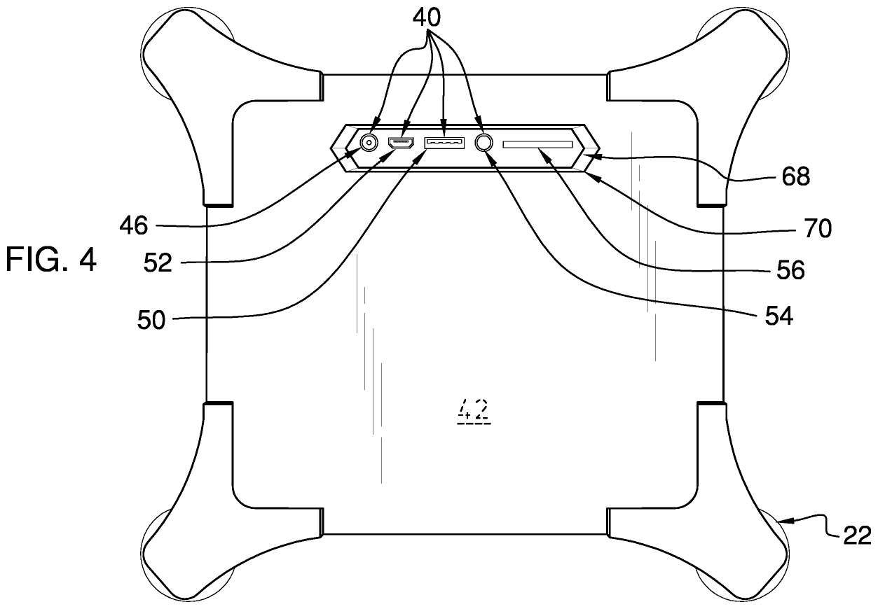

A plurality of connectors 40 engaged to a second face 42 of the display housing 28, as shown in FIG. 4. Each connector 40 is operationally engaged to one or more of the display battery 34 and the microprocessor 36. The connector 40 is configured for one of more of engaging a charging cord 44 to charge the display battery 34 and engaging a cable (not shown) for communication of commands or data to the microprocessor 36.

The plurality of connectors 40 comprises a charging port 46, which is configured for selective insertion of a charging plug 48 of the charging cord 44. The plurality of connectors 40 also may comprise one or more of a Universal Serial Bus port 50 and a micro-Universal Serial Bus port 52, either of which could be used for entering preprogrammed messages 20 onto the data storage module 38. The plurality of connectors 40 also may comprise a headphone jack 54.

A slot 56 is positioned in the second face 42 of the display housing 28. The slot 56 is operationally engaged to the microprocessor 36 and is configured for insertion of a data card (not shown). The data card could contain preprogrammed messages 20 for display on the screen 18, audio files for output through the headphone jack 54 to a pair of headphones (not shown), as well as other data.

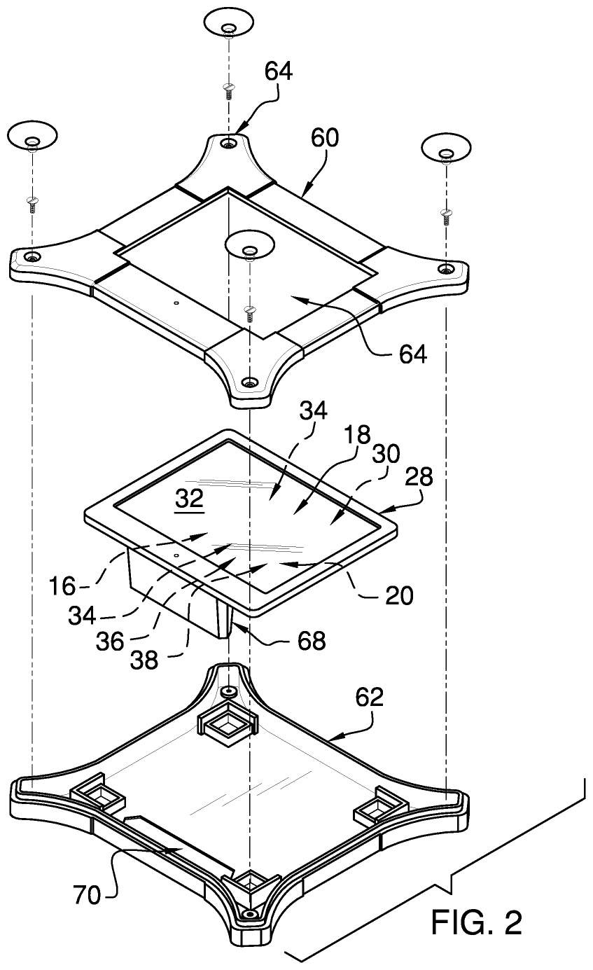

The electronic signage assembly 10 also may comprise a cover housing 58, which comprises a front piece 60 and a rear piece 62, as shown in FIG. 2. The front piece 60 is selectively engageable to the rear piece 62 so that the cover housing 58 substantially encapsulates the message module 12. A portion 64 of the front piece 60 is substantially transparent and overlays the screen 18 so that the respective preprogrammed message 20 is visible. The plurality of cups 22 is engaged to the front piece 60. Each cup 22 is engaged to the front piece 60 proximate to a respective corner 66 of the front piece 60. The plurality of connectors 40 is engaged to a protrusion 68 of the display housing 28 that extends through an aperture 70 positioned in the rear piece 62.

The remote controller 14 comprises a transmitter 72 and a selector 74. The transmitter 72 is in wireless communication with the receiver 16. The selector 74 is communicatively engaged to the transmitter 72 and is configured for input of a selection by a user of a respective preprogrammed message 20. The transmitter 72 communicates the selection to the message module 12 for display of the respective preprogrammed message 20 to persons proximate to the vehicle 26.

The remote controller 14 also comprises a controller housing 76, which defines an internal space 78. The transmitter 72 and a controller battery 80 are engaged to the controller housing 76 and are positioned in the internal space 78. The controller battery 80 is operationally engaged to the transmitter 72. The selector 74 is engaged to a first surface 82 of the controller housing 76. The selector 74 may comprise a plurality of buttons 84, which are depressible, or other selection means, such as, but not limited to, dials, touch screens, and the like. Each button 84 is configured to be selectively depressed to actuate the transmitter 72 to communicate a selection of an associated preprogrammed message 20 to the message module 12.

In use, the message module 12 is mounted to a window 24 of a vehicle 26 using the plurality of cups 22. The selector 74 is utilized by a user for selection by of a respective preprogrammed message 20. The transmitter 72 communicates the selection to the message module 12 for display of the respective preprogrammed message 20 to persons proximate to the vehicle 26. Preprogrammed messages 20 can be selected as needed in different situations while driving. For example, Thank You (as shown in FIG. 7), Please Slow Down, Safe to Cross, Safe to Pass, Please Let Me Merge, and I Am Making a U-Turn, are preprogrammed messages 20 that would be useful for a user to communicate in appropriate situations while driving. The present invention also anticipate respective preprogrammed messages comprising advertisements.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An electronic signage assembly comprising:
a message module comprising a receiver and a screen, the screen being rectangular and communicatively engaged to the receiver, wherein the screen is configured for selectively displaying a respective preprogrammed message of a plurality of preprogrammed messages;
a plurality of cups engaged to the message module, the cups being resiliently compressible, Wherein the cups are configured for compressing between the message module and a window of a vehicle for sectionally mounting the message module to the window, such that the screen is visible through the window;
a cover housing being engageable with the message module to substantially encapsulate the message module, the cover housing having a rectangular section and a plurality of arm sections, each arm section being coupled to a respective corner of the rectangular section and extending radially out from the rectangular section, the rectangular section being positioned concentrically to the screen when the cover housing substantially encapsulates the message module, the rectangular section having one of a substantially transparent portion and an aperture overlaying the screen when the cover housing encapsulates the message module such that the respective preprogrammed message is visible, each cup being engaged to an associated one of the plurality of arm sections of the front piece, each cup being positioned adjacent to a distal end of the associated one of the plurality of arm sections relative to the rectangular section; and
a remote controller comprising a transmitter and a selector, the transmitter being in wireless communication with the receiver, the selector being communicatively engaged to the transmitter and configured for inputting of a selection by a user of a respective preprogrammed message, such that the transmitter communicates the selection to the message module for displaying the respective preprogrammed message to persons proximate to the vehicle.

2. The electronic signage assembly of claim 1, wherein the message module comprises:
a display housing defining an interior space, the receiver being engaged to the display housing and positioned in the interior space, the screen being engaged to a first face of the display housing;
a display battery engaged to the display housing and positioned in the interior space;
a microprocessor engaged to the display housing and positioned in the interior space, the microprocessor being operationally engaged to the receiver, the display battery, and the screen; and
a data storage module engaged to the housing, positioned in the interior space, and operationally engaged to the microprocessor, the plurality of preprogrammed messages being positioned on the data storage module.

3. The electronic signage assembly of claim 2, further including the message module comprising a plurality of connectors engaged to a second face of the display housing opposite the first face, each connector being operationally engaged to one or more of the display battery and the microprocessor, wherein the connector engaged to the display battery is configured for engaging a charging cord for charging the display battery, wherein the connector engaged to the microprocessor is configured for engaging a cable for communication of commands or data to the microprocessor.

4. The electronic signage assembly of claim 3, wherein the plurality of connectors comprises:
a charging port configured for selective insertion of a charging plug of a charging cord;
a Universal Serial Bus port;
a micro-Universal Serial Bus port; and
a headphone jack.

5. The electronic signage assembly of claim 2, further including the message module comprising a slot positioned in the second face of the display housing, the slot being operationally engaged to the microprocessor, wherein the slot is configured for insertion of a data card.

6. The electronic signage assembly of claim 1, wherein the cups comprise rubber, silicone, or elastomer.

7. The electronic signage assembly of claim 3, further including:
a cover housing comprising:
a front piece being defined by the rectangular section and the plurality of arm sections, and
a rear piece being selectively engageable to the front piece, such that the cover housing substantially encapsulates the message module; and
the plurality of connectors being engaged to a protrusion of the display housing extending through an aperture positioned in the rear piece, the protrusion extending away from the second face of the display housing, the plurality of connectors being engaged to a distal end of the protrusion relative to the second face.

8. The electronic signage assembly of claim 7, wherein each cup is engaged to the front piece proximate to a respective corner of the front piece.

9. The electronic signage assembly of claim 1, wherein the remote controller comprises:
a controller housing defining an internal space, the transmitter being engaged to the controller housing and positioned in the internal space;
a controller battery engaged to the controller housing and positioned in the internal space, the controller battery being operationally engaged to the transmitter; and
the selector being engaged to a first surface of the controller housing.

10. The electronic signage assembly of claim 9, wherein the selector comprises a plurality of buttons, the buttons being depressible, wherein each button is configured for being selectively depressed for actuating the transmitter for communicating a selection of an associated preprogrammed message to the message module.

11. An electronic signage system comprising:
a vehicle comprising a window;
a message module comprising a receiver and a screen, the screen being rectangular and communicatively engaged to the receiver, wherein the screen is configured for selectively displaying a respective preprogrammed message of a plurality of preprogrammed messages;
a plurality of cups engaged to the message module, the cups being resiliently compressible, the cups being compressed between the message module and the window, such that the message module is suctionally mounted to the window with the screen being visible through the window;
a cover housing being engageable with the message module to substantially encapsulate the message module, the cover housing having a rectangular section and a plurality of arm sections, each arm section being coupled to a respective corner of the rectangular section and extending radially out from the rectangular section, the rectangular section being positioned concentrically to the screen when the cover housing substantially encapsulates the message module, the rectangular section having one of a substantially transparent portion and an aperture overlaying, the screen when the cover housing encapsulates the message module such that the respective preprogrammed message is visible, each cup being engaged to an associated one of the plurality of arm sections of the front piece, each cup being positioned adjacent to a distal end of the associated one of the plurality of arm sections relative to the rectangular section; and
a remote controller comprising a transmitter and a selector, the transmitter being in wireless communication with the receiver, the selector being communicatively engaged to the transmitter and configured for inputting of a selection by a user of a respective preprogrammed message, such that the transmitter communicates the selection to the message module for displaying the respective preprogrammed message to persons proximate to the vehicle.

12. An electronic signage assembly comprising:
a message module comprising a receiver and a screen, the screen being rectangular and communicatively engaged to the receiver, wherein the screen is configured for selectively displaying a respective preprogrammed message of a plurality of preprogrammed messages, the message module comprising:
a display housing defining an interior space, the receiver being engaged to the display housing and positioned in the interior space, the screen being engaged to a first face of the display housing,
a display battery engaged to the display housing and positioned in the interior space,
a microprocessor engaged to the display housing and positioned in the interior space, the microprocessor being operationally engaged to the receiver, the display battery, and the screen,
a data storage module engaged to the housing, positioned in the interior space, and operationally engaged to the microprocessor, a plurality of preprogrammed messages being positioned on the data storage module,
a plurality of connectors engaged to a second face of the display housing opposite the first face, each connector being operationally engaged to one or more of the display battery and the microprocessor, wherein the connector engaged to the display battery is configured for engaging a charging cord for charging the display battery, wherein the connector engaged to the microprocessor is configured for engaging a cable for communication of commands or data to the microprocessor, the plurality of connectors comprising:
a charging port configured for selective insertion of a charging plug of a charging cord,
a Universal Serial Bus port,
a micro-Universal Serial Bus port, and
a headphone jack, and
a slot positioned in the second face of the display housing, the slot being operationally engaged to the microprocessor, wherein the slot is configured for insertion of a data card;
a plurality of cups engaged to the message module, the cups being resiliently compressible, wherein the cups are configured for compressing between the message module and a window of a vehicle for suctionally mounting the message module to the window, such that the screen is visible through the window, the cups comprising rubber, silicone, or elastomer;
a cover housing being engageable with the message module to substantially encapsulate the message module, the cover housing having a rectangular section and a plurality of arm sections, each arm section being coupled to a respective corner of the rectangular section and extending radially out from the rectangular section, the rectangular section being positioned concentrically to the screen when the cover housing substantially encapsulates the message module, the rectangular section having one of a substantially transparent portion and an aperture overlaying the screen when the cover housing encapsulates the message module such that the respective preprogrammed message is visible, each cup being engaged to an associated one of the plurality of arm sections of the front piece, each cup being positioned adjacent to a distal end of the associated one of the plurality of arm sections relative to the rectangular section, the cover housing including a front piece being defined by the rectangular section and the plurality of arm sections, the cover housing including a rear piece being selectively engageable to the front piece, such that the cover housing substantially encapsulates the message module, the plurality of connectors being engaged to a protrusion of the display housing extending through an aperture positioned in the rear piece the protrusion extending away from the second face of the display housing, the plurality of connectors being engaged to a distal end of the protrusion relative to the second face; and
a remote controller comprising a transmitter and a selector, the transmitter being in wireless communication with the receiver, the selector being communicatively engaged to the transmitter and configured for inputting of a selection by a user of a respective preprogrammed message, such that the transmitter communicates the selection to the message module for displaying the respective preprogrammed message to persons proximate to the vehicle, the remote controller comprising:
a controller housing defining an internal space, the transmitter being engaged to the controller housing and positioned in the internal space,
a controller battery engaged to the controller housing and positioned in the internal space, the controller battery being operationally engaged to the transmitter, and
the selector being engaged to a first surface of the controller housing, the selector comprising a plurality of buttons, the buttons being depressible, wherein each button is configured for being selectively depressed for actuating the transmitter for communicating a selection of an associated preprogrammed message to the message module.
